(19) United States
(12) Patent Application Publication
(10) Pub. No.: US 2007/0282928 A1
(43) Pub. Date: Dec. 6, 2007

(54) Processor core stack extension

(76) Inventors: Guofang Jiao, San Diego, CA (US); Yun Du, San Diego, CA (US); Chun Yu, San Diego, CA (US)

Correspondence Address: QUALCOMM INCORPORATED, 5775 MOREHOUSE DR., SAN DIEGO, CA, 92121, US

(21) Appl. No.: 11/448,272

(22) Filed: Jun. 6, 2006

(51) Int. Cl. G06F 17/30

(52) U.S. Cl. 707/204

(57) ABSTRACT

In general, the disclosure is directed to techniques for controlling stack overflow. The techniques described herein utilize a portion of a common cache or memory located outside of the processor core as a stack extension. A processor core monitors a stack within the processor core and transfers the content of the stack to the stack extension outside of the processor core when the processor core stack exceeds a maximum number of entries. When the processor core determines the stack within the processor core falls below a minimum number of entries the processor core transfers at least a portion of the content maintained in the stack extension into the stack within the processor core. The techniques prevent malfunction and crash of threads executing within the processor core by utilizing stack extensions outside of the processor core.

### TECHNICAL FIELD

The disclosure relates to maintaining stack data structures of a processor.

### BACKGROUND

Conventional processors maintain a stack data structure (“stack”) that includes a number of control instructions. The stack is typically located within the core of the processor. Threads executing within the processor core may perform two basic operations to the stack. The control unit may either “push” control instructions onto the stack or “pop” control instructions off of the stack.

A push operation adds a control instruction to the top of the stack, causing the previous control instructions to be pushed down the stack. A pop operation removes and returns the current top control instruction of the stack, causing the previous control instructions to move one location up the stack. Thus, the stack of the processor core acts in accordance with a last in first out (LIFO) scheme.

Due to a limited size of memory within the core of the processor, the stack is quite small. The small size of the stack limits the number of nested control instructions that may be utilized. Pushing too many control instructions onto the stack results in stack overflow, which may cause one or more of the threads to malfunction and crash.

### SUMMARY

In general, the invention is directed to techniques for controlling stack overflow. The techniques described herein utilize a portion of a common cache or memory located outside of a processor core as a stack extension. A processor core maintains a stack within memory in the processor core. The processor core transfers at least a portion of the stack contents to a stack extension residing outside of the processor core when the processor core stack exceeds a threshold size, e.g., a threshold number of entries. For example, the processor core may transfer at least a portion of the content of the stack to the stack extension when the core stack becomes full. The stack extension resides within a cache or other memory outside of the processor core, and supplements the limited stack size available within the processor core.

The processor core also determines when the stack within the processor core falls below a threshold size, e.g., a threshold number of entries. For example, the threshold number of entries may be zero. In this case, when the stack becomes empty, the processor core transfers at least a portion of the content maintained in the stack extension back into the stack within the processor core. In other words, the processor core repopulates the stack within the processor core with the content of the stack extension outside the processor core. Hence, stack content can be swapped back and forth between the processor core and common cache, or other memory, to permit the size of the stack to be extended and contracted. In this manner, the techniques prevent malfunction or crash of threads executing within the processor core by utilizing stack extensions outside of the processor core.

In one embodiment, the disclosure provides a method comprising determining whether contents of a stack within a core of a processor exceeds a threshold size, and transferring at least a portion of the contents of the stack to a stack extension outside the core of the processor when the contents of the stack exceed the threshold size.

In another embodiment, the disclosure provides a device comprising a processor with a processor core that includes a control unit to control operation of the processor, and a first memory storing a stack within the processor core, and a second memory storing a stack extension outside the processor core, wherein the control unit transfers at least a portion of contents of the stack to the stack extension when the contents of the stack exceed the threshold size.

The techniques of this disclosure may be implemented using hardware, software, firmware, or any combination thereof. If implemented in software, the techniques of disclosure may be embodied on a computer readable medium comprising instructions that, upon execution by a processor, perform one or more of the techniques described in this disclosure. If implemented in hardware, the techniques may be embodied in one or more processors, application specific integrated circuits (ASICs), field programmable gate arrays (FPGAs), and/or other equivalent integrated or discrete logic circuitry.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a system that manages core stack data structures in accordance with the techniques described herein.

FIG. 2 is a block diagram illustrating another exemplary system that controls stack overflow by utilizing memory outside of the processor core as a stack extension.

FIG. 3 is a block diagram illustrating the system of FIG. 1 in further detail.

FIG. 4 is a block diagram illustrating a core stack and stack extensions in further detail.

FIG. 5 is a flow diagram illustrating exemplary operation of a system pushing entries to a stack extension of a common cache to prevent stack overflow of a core stack.

FIG. 6 is a flow diagram illustrating exemplary operation of a system retrieving entries stored on a stack extension.

### DETAILED DESCRIPTION

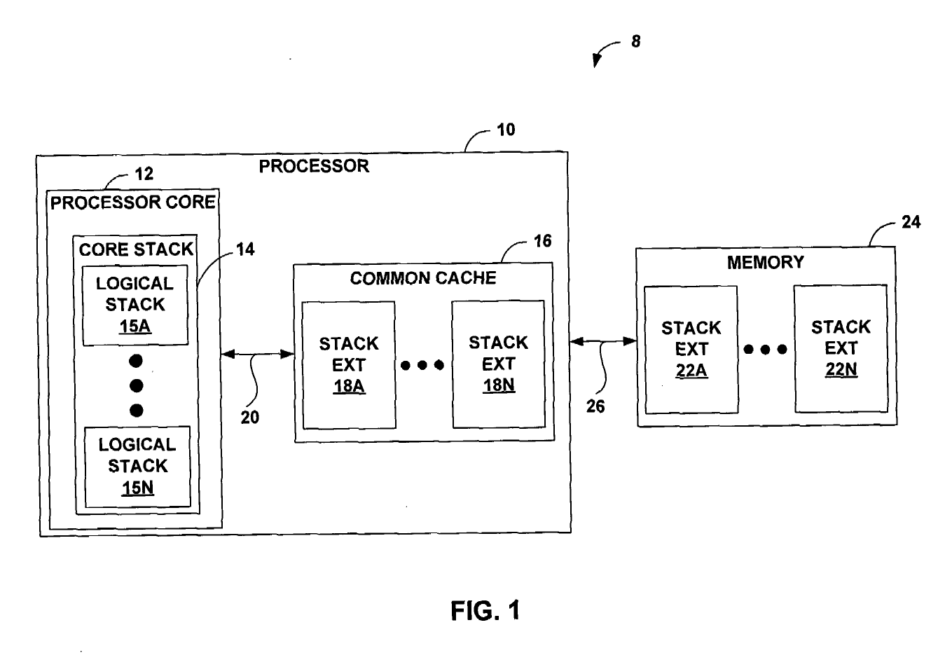

FIG. 1 is a block diagram illustrating a device 8 that manages core stack data structures in accordance with the techniques described herein. Device 8 controls stack overflow by utilizing memory located outside of a processor core 12 of a processor 10 as a stack extension, thus allowing device 8 to extend the size of the stack. To implement nested dynamic flow control instructions such as LOOP/End Loop and CALL/Ret commands, for example, a stack 14 within processor core 12 is necessary. The size of core stack 14 determines the number of recursive nestings, thus limiting the capability of processors for any applications. Device 8 economically provides an environment in which a large number of nested flow control instructions can be implemented. By using a stack extension, device 8 may support a larger number of nested flow control instructions.

In the example of FIG. 1, processor 10 comprises a single core processor. Thus, processor 10 includes a single processor core 12, which provides an environment for running a number of threads of a software application, such as a multimedia application. In other embodiments, processor 10 may include multiple processor cores. Processor core 12 may include, for example, a control unit that controls operation of processor 10, an arithmetic logic unit (ALU) to perform arithmetic and logic computations, and at least some amount of memory, such as a number of registers or a cache. Processor core 12 forms a programmable processing unit within processor 10. Other parts of processor 10, such as fixed function pipelines or co-working units, may be located outside processor core 12. Again, processor 10 may include a single processor core or multiple processor cores.

Processor core 12 dedicates at least a portion of the local memory of processor core 12 as a core stack data structure 14 (referred to herein as “core stack 14”). Core stack 14 is of a fixed size and contains stack entries, such as control instructions or data, associated with the threads of the application. Core stack 14 may, for example, be configured to hold a total of sixteen entries, thirty-two entries, sixty-four entries, or larger numbers of entries. In one embodiment, core stack 14 may comprise a portion of a Level 1 (L1) cache of the processor core 12. The size of core stack 14, therefore, may be limited by the size of the L1 cache, or the portion of the L1 cache dedicated to storing control instructions.

Core stack 14 is configurable into logical stacks 15A-15N (“logical stacks 15”). Processor core 12 dynamically subdivides core stack 14 into logical stacks 15 to accommodate multiple threads associated with the current application. Each of logical stacks 15 may correspond to one of the threads of the application currently running on processor 10. The number and size of logical stacks 15 depend on the number of threads that simultaneously run in the current application. Processor core 12 may subdivide core stack 14 differently for each application based on the number of concurrent threads associated with a particular application.

The larger the number of threads executing for an application, the larger is the number of logical stacks 15 and the smaller is the size of logical stacks 15. Conversely, the smaller the number of threads executing for an application, the smaller is the number of logical stacks 15 and the larger is the size of logical stacks 15. The number of threads associated with an application may, for example, be determined by a software driver according to the resource requirements of the specific multimedia application. Such configurability can maximize the utilization of total stacks and provide flexibility for different application needs. Logical stacks 15 ordinarily will each have the same size for a given application, but the size may be different for different applications.

The threads running on processor core 12 push control instructions onto core stack 14 and pop control instructions off core stack 14 to control execution of the application. More specifically, the threads push control instructions onto and pop control instructions off of the logical stack 15 associated with the thread. Because core stack 14 and logical stacks 15 are of a fixed size, the number of control instructions that the threads may push onto the stacks is limited. Pushing too many control instructions onto one of the logical stacks 15 results in stack overflow, which may cause one or more of the threads to malfunction and crash.

To reduce the likelihood of stack overflow, device 8 utilizes memory outside of processor core 12 as a stack extension. Device 8 may utilize a portion of a common cache 16, an external memory 24 or both as the stack extension or extensions. Common cache 16 may be used by a single processor core or shared by multiple processor cores within a multi-core processor.

Common cache 16 generally refers to a cache memory located outside of processor core 12. Common cache 16 may be located inside processor 10 and coupled to processor core 12 via an internal bus 20, as illustrated in FIG. 1, and hence use the same bus as other internal processor resources. Common cache 16 may, for example, comprise a Level 2 (L2) cache of processor 10, whereas core stack 14 may comprise a Level 1 (L1) cached of the processor. Alternatively, common cache 16 may be located outside of processor 10, such as on a mother board or other special module to which processor 10 is attached.

As a further alternative, an external memory 24 may be used as a supplemental stack extension either alone or in addition to common cache 16. Memory 24 is located outside of processor 10, such as on a mother board or other special module to which processor 10 is attached. Processor 10 is coupled to memory 24 via external bus 26. External bus 26 may be the same data bus used by processor 10 to access other resources and thus eliminate the need for additional hardware. Memory 24 may comprise, for example, general purpose random access memory (RAM).

Device 8 maintains stack extension data structures 18A-18N (labeled “STACK EXT 18” in FIG. 1) within common cache 16. Each of stack extensions 18 corresponds to one of logical stacks 15, and thus is associated with one of the threads running in processor core 12. When a thread wants to push a new control instruction onto the corresponding one of logical stacks 15 (e.g., logical stack 15A), and logical stack 15A exceeds a threshold size, such as a threshold number of entries, e.g., when logical stack 15A is full or nearly full, processor core 12 transfers at least a portion of the contents of the corresponding logical stack 15A to common cache 16. More specifically, processor core 12 writes contents of logical stack 15A to one of stack extensions 18 associated with the logical stack 15A (e.g., stack extension 18A). In one embodiment, processor core 12 may issue a swap-out command to write the entire stack out to stack extension 18A of common cache 16. If corresponding logical stack 15A exceeds a threshold size, e.g., number of entries, again, processor core 12 would transfer more of the contents of the logical stack 15A to the corresponding stack extension 18A located in common cache 16, pushing the previously transferred control instructions further down stack extension 18A.

Device 8 may maintain additional stack extension data structures 22A-22N (labeled “STACK EXT 22” in FIG. 1), e.g., within memory 24. Each of stack extensions 22 is associated with one of the threads running in processor core 12. Stack extensions 22 may be utilized to control overflow of stack extensions 18 in common cache 16. When a stack extension 18 of common cache 16 becomes full, for example, device 8 may swap-out at least a portion of the contents of the stack extension 18 to stack extension 22A in memory 24, e.g., in a manner similar to the transfer of the contents of logical stack 15A to stack extension 18A. In this manner, device 8 may control stack overflow using a multi-level stack extension, i.e., with a first-level portion of the stack extension being located within common cache 16 and a second-level portion located within memory 24. Alternatively, in some embodiments, device 8 may transfer contents of logical stack 15A directly to stack extension 22A of memory 24 to control overflow of logical stack 15A.

A software driver within device 8 may form stack extensions, such as stack extensions 18, by allocating a portion of common cache as a memory space with a starting address and enough size to accommodate a desired number of stack extensions 18 of a known length. The allocated portion of common cache memory storage may be contiguous or non-contiguous. Device 8 may divide the allocated space into a number of equally sized stack extensions 18 in a manner similar to division of core stack 14 into logical stacks 15. The number and size of stack extensions 18 may be dependent on the number of threads of the application executing within processor 10, and hence the number of logical stacks 15. When a logical stack 15 is swapped out to common cache 16, device 8 writes the content of the logical stack into the corresponding stack extension 18 beginning at a start address of the stack. The starting address may be computed according to the equation:

start address=bottom address+virtual counter*unit size of a stack entry, (1)

where the bottom address refers to the address of the bottom entry in the stack extension 18, the unit size of the stack entry refers to the unit size, e.g., in bytes, of each stack entry, and the virtual counter tracks the number of stack entries to be swapped from logical stack 15 to the stack extension in common cache 16. In this manner, device 8 borrows a portion of common cache memory storage for stack extensions. Each stack extension is assigned a fixed size by a software driver. When a logical stack 15 is swapped out of core stack 14, device 8 writes the stack entries of the logical stack into the virtual stack space one by one from the start address. When the virtual stack is full, its contents may be swapped to a further stack extension 22 in off-chip memory 24.

As an alternative to swapping logical stack 15 back and forth between core stack 14 and stack extension 18 in common cache 16, cache 16 and core stack 14 may be treated as one continuous, addressable stack in a true cache mode. In particular, device 8 may form stack extensions 18 by automatically allocating individual stack extension entries in common cache 16 as the size of the combined stack spanning core stack 14 and common cache 16 grows. In this way, a true stack extension is allocated by a software driver associated with device 8, such that the content of a given stack is accessed as a continuous stack spanning both stack entries in core stack 14 inside processor core 12 and stack entries in common cache 16. In other words, core stack 14 and common cache 16 are used to store a continuous span of stack entries as a common stack, rather than by swapping logical stacks 15 between core stack 14 and common cache 16.

For this alternative cache approach, processor core 12 maintains a virtual counter and a start address for each stack extension 18. Device 8 maps each stack entry onto a portion of the L1 cache entry, i.e., core stack 14. In this manner, stack extensions 18 may be viewed as “virtual” stack extensions. When writing to or reading from a cache entry, if there is an L1 cache hit, device 8 writes in/reads out from the cache entry in core stack 14. If there is a cache miss, device 8 instead reads or writes relative to common cache 16, e.g., L2 cache. Common cache 16 maps the same memory address onto a portion of L2 cache. If there is an L2 cache hit, device 8 writes the cache entry into L2 cache or reads the cache entry from L2 cache. If there is no cache hit at L1 or L2, the cache entry will be discarded or directed to off-chip memory, if available, according to the same memory address. The mapping of a memory address onto a cache entry may be, for example, done by using some bits in the middle of the memory address as an index and other bits as a TAG to check cache hit or miss.

With further reference to the cache-swapping approach, when a thread needs to pop control instructions off logical stack 15A, the thread causes processor core 12 to pop off the control instruction located on the top of the stack, and performs the operation specified by the control instruction. In other words, the process thread causes processor core 12 to pop off control instructions in accordance with a last in first out (LIFO) scheme.

Processor core 12 continues to pop off control instructions for the thread until the number of entries in corresponding logical stack 15A falls below a threshold size, e.g., a threshold number of entries. In one embodiment, the threshold is reached when the logical stack is empty, i.e., there are zero entries. In other embodiments, the threshold may be selected to correspond to a state in which the logical stack is nearly empty.

When logical stack 15A falls below the threshold, processor core 12 transfers the top portion of the corresponding stack extension 18A of common cache 16 into logical stack 15A. Processor core 12 may, for example, issue a swap-in command to read in the top portion of stack extension 15A of common cache 16. The top portion may be sized to conform to the size of the core stack. Thus, processor core 12 re-populates logical stack 15A with entries stored in the associated stack extension 18A of common cache 16. Logical stack 15A may be completely filled or only partially filed with entries stored in the stack extension 18A.

Likewise, the entries of stack extension 22A of memory 24 may be transferred into either stack extension 18A or logical stack 15A when the stack extension or logical stack reach applicable threshold levels. Device 8 may, for example, transfer a top portion of stack extension 22A to stack extension 18A when the number of entries in stack extension 18A falls below a threshold. Alternatively, device 8 may, for example, transfer the top portion of stack extension 22A to logical stack 15A when the number of entries in logical stack 15A falls below a threshold. Again, the transferred portion may completely fill or partially fill the stack extension 22A or logical stack 15A, as applicable.

Processor core 12 continues to pop off and transfer control instructions until all the control instructions of logical stack 15A, stack extension 18A and stack extension 22A have been executed or until the processor resources are transferred to another one of the threads executing within processor core 12. The other threads cause processor core 12 to pop off and push on control instructions to an associated logical stack 15 and stack extensions 18 and 22 in the same manner. Thus, processor 10 controls stack overflow by utilizing a portion of common cache 16 and/or memory 24 as a stack extension, allowing processor 10 to implement a much larger, if not unlimited, number of nested flow control instructions.

Processor core 12 transfers control instructions from logical stacks 15 to stack extensions 18 via internal bus 20. Internal bus 20 may be the same bus used by other resources accessed by processor core 12. Processor core 12 may, for example, write data to storage buffers or registers of common cache 16 using internal bus 20. Thus, the swap-in and swap-out commands issued by processor core 12 may use the same data path of other resource accessing, such as instruction fetch and generic load/store buffers or virtual register files outside of processor core 12. In this manner, processor core 12 transfers control instructions to the stack extensions 18 of common cache 16 with no need for additional hardware.

The techniques of the invention are described with respect to implementing an increased number of nested flow control instructions for exemplary purposes only. The techniques may also be utilized to implement a stack of virtually unlimited size for storing different data. For example, the techniques may be utilized to implement a stack of expanded size that stores data of an application via explicit push and pop instructions programmed by an application developer.

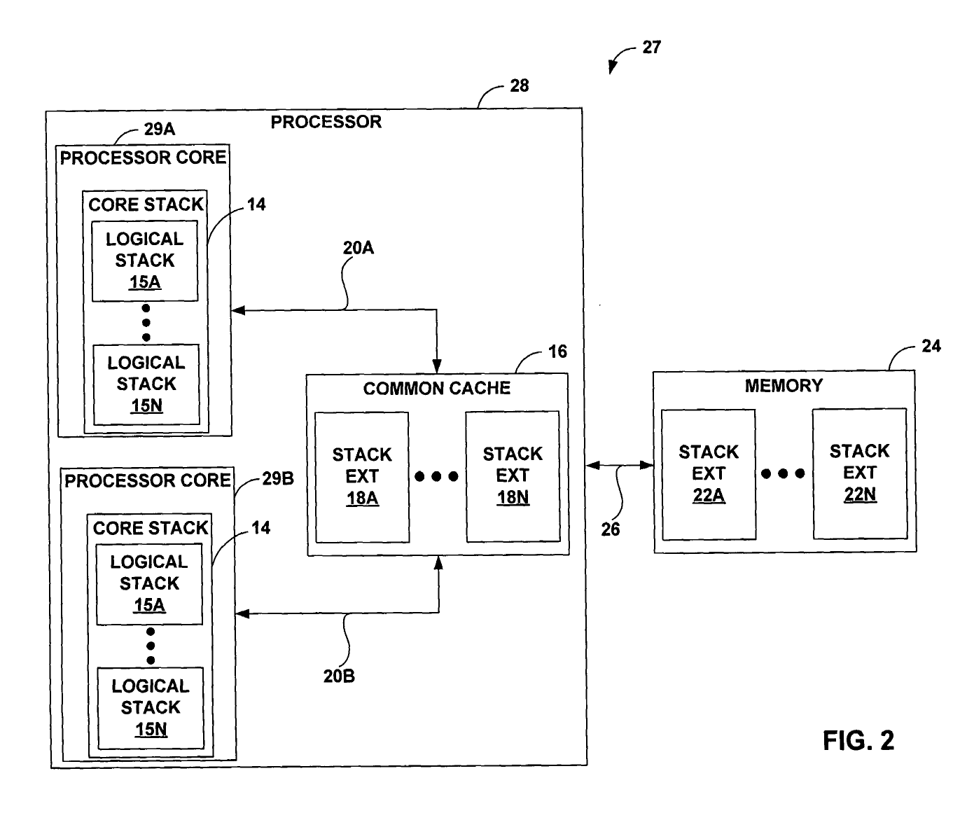

FIG. 2 is a block diagram of a device 27 that controls stack overflow by utilizing memory located outside of the processor core as a stack extension. Device 27 includes a multi-core processor 28 that includes a first processor core 29A and a second processor core 29B (collectively, “processor cores 29”). Device 27 conforms substantially to device 8 of FIG. 1, but device 27 includes multiple processor cores 29 instead of a single processor core. Device 27 and, more particularly, each of processor cores 29 operate in the same manner as described in FIG. 1. In particular, device 27 maintains core stacks 14 within each of processor cores 29 and controls stack overflow of core stacks 14 using stack extensions 18 of common cache 16, stack extensions 22 of memory 26 or a combination of the stack extensions 18 and 22. Stack extensions 18 for different processor cores 29 typically will not be overlapped. Instead, separate stack extensions 18 are maintained for different processor cores 29.

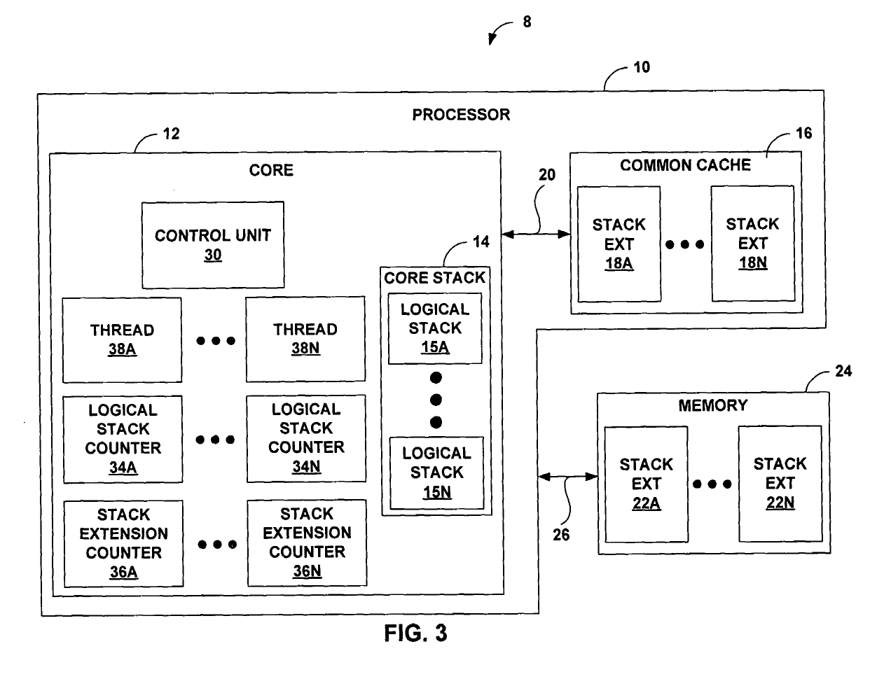

FIG. 3 is a block diagram illustrating device 8 of FIG. 1 in further detail. Device 8 utilizes memory outside of processor core 10 as a stack extension to control stack overflow. Device 8 includes a memory 24 and a processor 10 with a processor core 12 that includes a control unit 30, a core stack 14, logical stack counters 34A-34N (“logical stack counters 34”), stack extension counters 36A-36N (“stack extension counters 36”), and threads 38A-38N (“threads 38”).

Control unit 30 controls operation of processor 10, including scheduling threads 38 for execution on processor 10. Control unit 30 may, for example, schedule threads 38 using fixed-priority scheduling, time slicing and/or any other thread scheduling method. The number of threads 38 that exists depends on the resource requirements of the specific application or applications being handled by processor 10.

When one of threads 38, e.g., thread 38A, is scheduled to run on processor core 12, thread 38A causes control unit 30 to either push stack entries, such as control instructions, onto the logical stack 15A or pop entries off logical stack 1 5A. As described above, control unit 30 transfers at least a portion of the content of logical stack 15A, and optionally the entire contents of logical stack 15A, to stack extensions 18 of common cache 16, stack extensions 22 of memory 24 or both in order to prevent overflow of logical stacks 15.

For each of threads 38, processor core 12 maintains a logical stack counter 34 and a stack extension counter 36. Logical stack counters 34 and stack extension counters 36 track the number of control instructions in logical stacks 15 and stack extensions 18 and 22, respectively. For example, logical stack counter 34A tracks the number of control instructions in logical stack 15A and stack extension counter 36A tracks the number of control instructions in stack extension 18A. Other ones of stack extension counters 36 may track the number of control instructions stored in stack extension 22A.

As described above, processor 10 controls stack overflow by utilizing a portion of common cache 16 as a stack extension, allowing processor 10 to implement a stack of expanded size, if not virtually unlimited size. Initially, control unit 30 begins to push new control instructions, or other data associated with an application, onto logical stack 15A for thread 38A. Control unit 30 increments logical stack counter 34A to reflect the new control instructions that were pushed onto logical stack 15A. Control unit 30 continues to push new control instructions onto logical stack 15A for thread 38A until logical stack 15A exceeds a threshold number of entries. In one embodiment, control unit 30 may push new control instructions onto logical stack 15A until logical stack 15A is full. In this manner, processor 10 reduces the number of times that it must transfer contents of logical stacks 15 to stack extensions 18.

Control unit 30 may determine for thread 38A that logical stack 15A exceeds the threshold when logical stack counter 34A reaches a maximum threshold. The maximum threshold may be determined when core stack 14 is subdivided into logical stacks 15, and may be equal to the size of each of logical stacks 15. When control unit 30 needs to push another control instruction onto logical stack 15A but determines that logical stack 15A meets or exceeds the threshold, control unit 30 transfers at least a portion of the contents of corresponding logical stack 15A to stack extension 18A. In one embodiment, control unit 30 transfers the entire content of logical stack 15A to stack extension 18A. For example, control unit 30 may issue a swap-out command to write the whole stack 15A to stack extension 18A in common cache 16. Alternatively, control unit 30 may transfer only a portion of the content of stack 15A to stack extension 18A. For example, control unit 30 may transfer only the bottom-most control instruction or instructions to stack extension 18A.

Similarly, control unit 30 may transfer a portion of the contents of stack extension 18A to stack extension 22A in a similar manner. In other words, control unit 30 may issue a swap-out command when stack extensions 18A of common cache 16 becomes full to transfer at least a portion of the contents of stack extension 18A of common cache 16 to stack extension 22A of memory 24. In this manner, device 8 may control stack overflow using a multi-level stack extension, i.e., a portion of the stack extension being located within common cache 16 and a portion located within memory 24. Alternatively, control unit 30 may transfer contents of logical stack 15A directly to stack extension 22A of memory 24 to control overflow of logical stack 15A. Logical stack counter 34A and stack extension counters 36A are adjusted to reflect the transfer of contents.

Control unit 30 adjusts logical stack counters 34 and stack extension counters 36 to reflect the transfer of entries among the stacks. In one embodiment, processor core 12 implements logical stack counter 34 and stack extension counters 36 associated with each of the threads as a single counter. For example, if the size of logical stack 15A is 4 entries, the size of stack extension 18A is 16 entries, and the size of stack extension 22A in off-chip memory is 64 entries, processor core 12 may use one stack counter having six bits. The two least significant bits (i.e., bits 0 and 1) represent the number of entries in logical stack 15A, the middle two bits (i.e., bits 2 and 3) represent the number of entries in stack extension 18A in common cache 16 and the two highest significant bits (i.e., bits 4 and 5) represent the number of entries in the stack extension 22A in off-chip memory 24.

Initially, the counter is set to −1, which means that there are no entries in any of the stacks. When logical stack 15A has four entries, the value of the six-bit counter is equal to three. When a new entry is to be pushed to the logical stack 15A, the value of the counter will be equal to four. This carry bit to the middle two bits will trigger a swap out command to swap the entire contents of logical stack 15A into corresponding stack extension 18A. After the swap, the value of the counter is equal to four; the lowest two bits equal zero indicating that there is one entry in logical stack 15A, the middle two bits equal one indicating that one logical stack has been overflowed into stack extension 15A.

When a logical stack has been overflowed three times, the middle two bits equal three. The next time overflow occurs, a swap out command is triggered to swap the entire content of stack extension 18A, which contains the contents of three logical stacks, plus newly overflowed logical stack content to off-chip memory 24. Then the highest two bits equal 1, meaning one time overflow of stack extension into off-chip memory 26. The middle two bits are equal to zero, meaning no copy of logical stack 15A is in the stack extension 18A. When a stack is popped empty, the applicable counter counts down in a similar fashion to swap in from off-chip memory to stack extension 18A and then to logical stack 15A.

Control unit 30 may transfer the control instructions of logical stack 15A as one continuous data block. In other words, control unit 30 may write the control instructions to stack extension 18A with a single write operation. Alternatively, control unit 30 may write the control instructions to stack extension 18A using more than one write operation. For example, control unit 30 may write the control instructions to stack extension 18A using a separate write operation for each of the individual control instructions of logical stack 15A.

While control unit 30 transfers the control instructions of logical stack 15A to stack extension 18A, control unit 30 places thread 38A into a SLEEP queue, opening an ALU slot for use by other threads 38. In other words, thread 38A is placed in an idle state, thus allowing another one of threads 38 to use the resources of processor core 12. The new thread re-uses the same mechanism as others in the processor core. For example, in the event of an instruction miss or memory access, before swapping data back, the current thread will be moved to the SLEEP queue and the ALU slot will be used by other threads 38.

Once the transfer of the control instructions is complete, control unit 30 reactivates thread 38A unless another thread has been given higher priority. In this manner, processor core 12 more efficiently uses its resources to execute the multiple threads, thus reducing the number of processing cycles wasted during the transfer of control instructions to stack extensions 18. Additionally, control unit 30 increments logical stack counter 34A and stack extension counter 36A to track the number of control instructions or other data within logical stack 15A and stack extension 18A, respectively.

Notably, the number of threads for an application executing in the processor core 12 at a given time does not necessarily correspond to the number of threads associated with an application. After one thread is complete, the thread space and logical stack space within core stack 14 can be re-used for a new thread. Thus, the number of threads using the core stack 14 at a given time is not the total number of threads of an application. For example, in some embodiments, processor core 12 may be configured to provide sufficient stack space for sixteen threads of a given application. At the same time, however, that application may have over ten-thousand threads. Accordingly, processor core 12 initiates and completes numerous threads while executing application, and is not limited to a fixed number of threads. Instead, threads re-use the same thread space and logical stack space on a repetitive basis during the course of execution of the application.

When control unit 30 needs to pop control instructions off of logical stack 15A for thread 38A, control unit 30 begins to pop off control instructions from the top of logical stack 15A and decrements logical stack counter 34A. When logical stack 15A falls below a minimum threshold, e.g., when logical stack counter 34A is zero, control unit 30 determines whether any control instructions associated with thread 38A are located in stack extension 18A. Control unit 30 may, for example, check the value of the stack extension counter 36A to determine whether any control instructions remain in stack extension 32. If there are control instructions in stack extension 18A, control unit 30 retrieves control instructions from the top portion of stack extension 18A to re-populate logical stack 15A. Control unit 30 may, for example, issue a swap-in command to read in the top portion of stack extension 15A of common cache 16. Swapping in the content of stack extension 18A when logical stack 15A is empty may reduce the number of swap-in commands.

Likewise, the entries of stack extension 22A of memory 24 are transferred into either stack extension 18A or logical stack 15A. Device 8 may, for example, transfer the top portion of stack extension 22A to stack extension 18A when the number of entries in stack extension 18A falls below a threshold. Alternatively, device 8 may, for example, transfer the top portion of stack extension 22A to logical stack 15A when the number of entries in logical stack 15A falls below a threshold. The top portion of stack extension 18A or stack extension 22A may correspond in size to the size of logical stack 15A.

While control unit 30 transfers control instructions to stack 15A, control unit 30 places thread 38A in an idle state, thus allowing other threads to utilize the resources of processor 12. Control unit 30 may, for example, place thread 38A in a SLEEP queue, thus opening an ALU slot for use by one of the other ones of threads 38. Once control unit 30 retrieves the control instructions, control unit 30 activates thread 38A unless another thread has been given higher priority during the time that thread 38A was idle. Moreover, control unit 30 adjusts stack extension counter 36A to account for the removal of the control instructions from stack extension 18A. Additionally, control unit 30 adjusts logical stack counter 34A to account for the control instructions placed in logical stack 15A.

Control unit 30 continues to pop off and execute control instructions from logical stack 15A for thread 38A. This process continues until all of the control instructions maintained in both logical stack 15A and stack extension 18A and 22A have been read and executed by thread 38A or until control unit 30 allocates the resources of processor core 12 to another one of threads 38. In this manner, processor 10 can implement an unlimited number of nested control instructions by pushing control instructions to stack extensions 18 and 22 and later retrieving those control instructions. As described above, however, processor 10 may utilize the techniques described herein to implement a stack of extended size to store data other than control instructions.

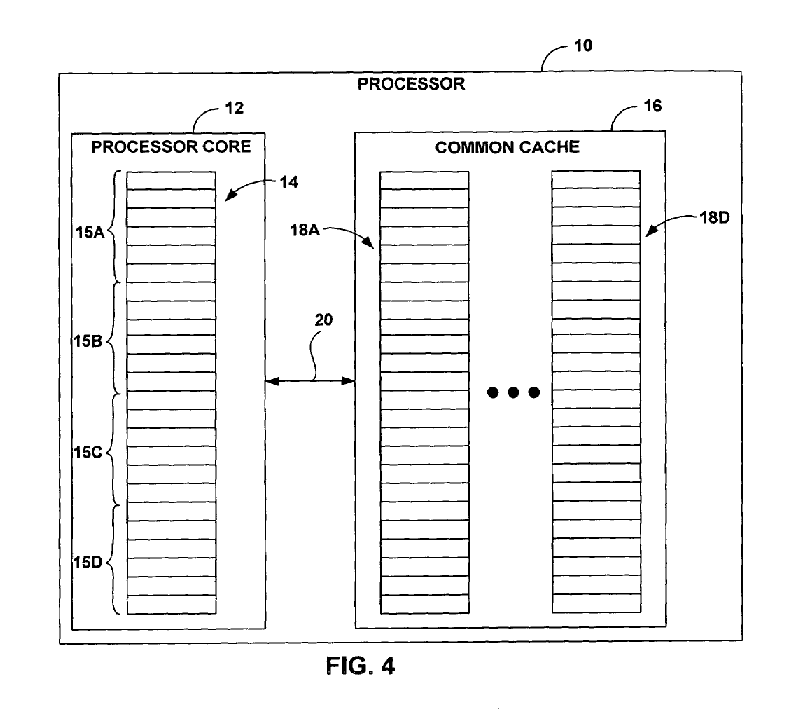

FIG. 4 is a block diagram illustrating core stack 14 and stack extensions 18 in further detail. As described above, core stack 14 is a data structure of a fixed size, and resides within memory in processor core 12. In the example illustrated in FIG. 4, core stack 14 is configured to hold twenty-four control instructions. Core stack 14 may be configured to hold any number of control instructions. The size of core stack 14 may, however, be limited by the size of memory inside processor core 12.

Core stack 14 is configurable into one or more logical stacks, with each of the logical stacks corresponding to a thread of an application. As described above, the number and size of logical stacks depend on the number of threads of the current application, which may be determined by a software driver according to the resource requirements of the specific application. In other words, processor core 12 dynamically subdivides core stack 14 differently for each application based on the number of threads associated with the particular application.

In the example illustrated in FIG. 4, core stack 14 is configured into four equally sized logical stacks 15A-15D (“logical stacks 15”). Logical stacks 15 each hold six entries, such as six control instructions. As described above, however, if an application includes a larger number of threads, core stack 14 would be subdivided into more logical stacks 15. For example, if the application includes six threads, core stack 14 may be configured into six logical stacks that each holds four control instructions. Conversely, if an application includes a smaller number of threads, core stack 14 would be subdivided into fewer logical stacks 15. Such configurability can maximize the utilization of total stacks and provide flexibility for different application needs.

Processor 10 controls stack overflow by transferring control instructions between logical stacks 15 within processor core 12 and stack extensions 18 within common cache 16. Each of stack extensions 18 corresponds to one of logical stacks 15. For example, stack extension 18A may correspond to logical stack 15A. However, stack extension 18A may be larger than logical stack 15A. In the example illustrated in FIG. 4, stack extension 18A is four times larger than logical stack 15A. Thus, processor core 12 may fill and transfer control instructions from logical stack 15A four times before stack extension 18A is full. Alternatively, stack extension 18A may be the same size as logical stack 15A. In this case, processor core 12 can only transfer control instructions of one full logical stack.

If, however, the stack extension is larger than size of common cache 16, common cache 16 may swap data into and from off-chip memory 24. Alternatively, a portion of the stack extension may be located within common cache 16 and a portion located within memory 24. Thus, processor 12 may truly implement an unlimited number of nest flow control instructions at a very low cost.

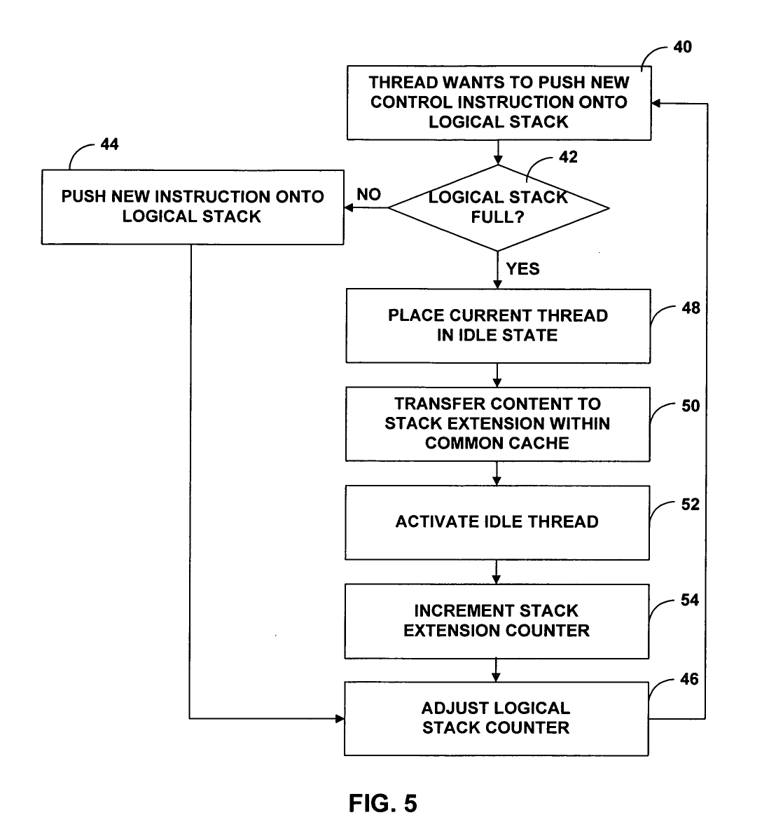

FIG. 5 is a flow diagram illustrating exemplary operation of processor 10 pushing control instructions to a stack extension of a common cache to prevent stack overflow of a core stack. Initially, control unit 30 determines a need to push a new control instruction onto a logical stack 15A associated with a thread, such as thread 38A (40). Control unit 30 may, for example, determine that a new loop must be executed and need to push a control instruction to return to a current loop after the new loop is complete.

Control unit 30 determines whether logical stack 15A meets or exceeds a maximum threshold (42). Control unit 30 may, for example, compare the value of logical stack counter 34A to a threshold value to determine whether logical stack 15A is full. The threshold value may, for example, be the size of logical stack 15A, which may be determined based on the size of core stack 14 and the number of threads that are associated with the current application.

If the number of entries in logical stack 15A does not exceed the maximum threshold, control unit 30 pushes the new control instruction onto logical stack 15A for thread 38A (44). Additionally, control unit 30 increments logical stack counter 46 to account for the new control instruction placed on logical stack 15A (46).

If the number of entries in logical stack 15A meets or exceeds the maximum threshold, control unit 30 places the current thread into an idle state (48). While thread 38A is idle, another one of threads 38 will use the resources of processor core 12. Additionally, control unit 30 transfers at least a portion of the content of logical stack 15A to corresponding stack extension 18A of common cache 16 (50). Control unit 30 may, for example, transfer the entire content of logical stack 15A to stack extension 18A. Control unit 30 may transfer the content of logical stack 15A in a single write operation or in multiple consecutive write operations. After the content of logical stack 15A is transferred to stack extension 18A, control unit 30 reactivates thread 38A (52).

Control unit 30 increments stack extension counter 36A to account for the control instructions that were transferred to stack extension 18A (54). In one embodiment, control unit 30 increments stack extension counter 36A as a function of the number of write operations. Additionally, control unit 30 adjusts logical stack counter 34A to account for the control instructions transferred from logical stack 15A (46). Control unit 30 may, for example, reset logical stack counter 34A to zero. Control unit 30 may then push the new control instruction onto logical stack 15A, which is now empty.

As described above, the stack management scheme may also use an off-chip memory 24 as a further stack extension. In particular, when stack extensions 18A of common cache 16 become full, for example, device 8 may swap-out at least a portion of the contents of stack extension 18A of common cache 16 to stack extension 22A of memory 24 in a similar fashion as the contents of logical stack 15A are transferred to stack extension 18A. In this manner, device 8 may control stack overflow using a multi-level stack extension, i.e., a portion of the stack extension being located within common cache 16 and a portion located within memory 24. Alternatively, device 8 may transfer contents of logical stack 15A directly to stack extension 22A of memory 24 to control overflow of logical stack 15A. Logical stack counter 32A and stack extension counters 34A are adjusted to reflect the transfer of contents.

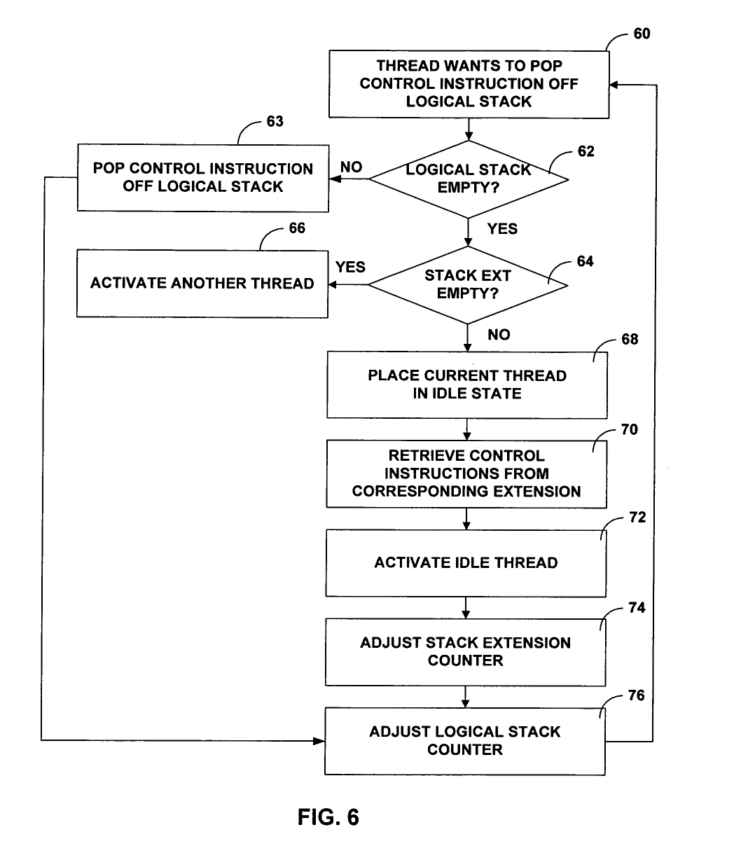

FIG. 6 is a flow diagram illustrating exemplary operation of processor 10 retrieving control instructions stored on a stack extension. Initially, if a thread want sto pop a control instruction off of the logical stack (60), and the logical stack is not empty (62), the control instruction is popped off the logical stack (63), and the logical stack counter is adjusted (76). Control unit 30 determines whether the number of entries in logical stack 15A falls below a minimum threshold. In one embodiment, control unit 30 determines whether logical stack 15 is empty (62). Hence, in this case, the threshold is zero. Control unit 30 may determine, for example, that logical stack 15A is empty when logical stack counter 34A is equal to zero. If the number of entries in logical stack 15A falls below the minimum threshold, control unit 30 attempts to pop off a subsequent control instruction from the top of stack extension 18A.

If the number of entries in logical stack 15A meets or falls below the minimum threshold, control unit 30 determines whether stack extension 18A is empty (64). Control unit 30 may determine, for example, that stack extension 18A is empty if stack extension counter 36A is equal to zero. If stack extension 18A is empty, all the control instructions associated with thread 38A have been executed and control unit 30 may activate another thread (66).

If stack extension 18A is not empty, control unit 30 places thread 38A into an idle state (68). While thread 38A is idle, another one of threads 38 will use the resources of processor core 12. Control unit 30 transfers the top portion of the corresponding stack extension 18A of common cache 16 into logical stack 15A (70). In one embodiment, control unit 30 retrieves enough control instructions from stack extension 18A to fill logical stack 15A. In other words, control unit 30 repopulates logical stack 15A with entries stored in the associated stack extension 18A of common cache 16. Control unit 30 reactivates idle thread 38A (72).

Moreover, control unit 30 adjusts stack extension counter 36A to account for the removal of the control instructions from stack extension 18A (74). Additionally, control unit 30 adjusts logical stack counter to account for the control instructions placed in logical stack 15A (76). Control unit 30 continues to pop off and execute control instructions from logical stack 15A.

Although the flow diagrams of FIGS. 5 and 6 describe processor 10 utilizing a stack extension within a common cache 16 located within processor 10, processor 10 may maintain and utilize a stack extension located in an external cache or memory outside of processor 10, as illustrated in FIG. 2. Alternatively, processor 10 may maintain a multi-level stack extension using both common cache 16 within processor 10 and either a cache or memory external to processor 10.

The techniques described in this disclosure provide a number of advantages. For example, the techniques provide a processor or other apparatus with the capability to economically implement a virtually unlimited number of nested flow control instructions or other application data of an application via explicit push and pop instructions programmed by an application developer. Moreover, the techniques utilize resources that already exist within the apparatus. For example, the processor or other apparatus issues swap-in and swap-out commands using a data path used for other resource access. The processor or other apparatus also uses already available memory outside of the processor core, such as the common cache or external memory. Furthermore, the techniques are completely transparent to the driver and applications running on the processor core.

The techniques described in this disclosure may be implemented in hardware, software, firmware or any combination thereof. For example, various aspects of the techniques may be implemented within one or more microprocessors, digital signal processors (DSPs), application specific integrated circuits (ASICs), field programmable logic arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry.

When implemented in software, the functionality ascribed to the systems and devices described in this disclosure may be embodied as instructions on a computer-readable medium such as random access memory (RAM), read-only memory (ROM), non-volatile random access memory (NVRAM), electrically erasable programmable read-only memory (EEPROM), FLASH memory, magnetic media, optical media, or the like. The instructions are executed to support one or more aspects of the functionality described in this disclosure

Various embodiments of the invention have been described. The embodiments described are for exemplary purposes only. These and other embodiments are within the scope of the following claims.

1. A method comprising:
determining whether contents of a stack within a core of a processor exceeds a threshold size; and
transferring at least a portion of the contents of the stack to a stack extension outside the core of the processor when the contents of the stack exceed the threshold size.

2. The method of claim 1, further comprising:
maintaining a plurality of stacks within the core of the processor, wherein each of the plurality of stacks corresponds to a different one of a plurality of threads of an application executed by the processor; and
maintaining a plurality of stack extensions outside the core of the processor, wherein each of the stack extensions corresponds to one of the stacks within the core of the processor,
wherein transferring at least a portion of the contents comprises transferring at least a portion of the contents of one of the stacks within the core of the processor to a corresponding stack extension.

3. The method of claim 2, wherein each of the stacks is equally sized and a number of the stacks corresponds to a number of the threads.

4. The method of claim 2, wherein each of the stacks is sized differently for different applications.

5. The method of claim 2, further comprising transferring at least a portion of the contents of a second one of the stacks within the core of the processor to a corresponding stack extension.

6. The method of claim 1, wherein the stack within the core of the processor is associated with a thread of an application, the method further comprising placing the thread of the application in an idle state while the contents of the stack within the core of the processor are transferred to the stack extension.

7. The method of claim 6, further comprising transferring the contents of the stack extension back to the stack, and placing the thread of the application in an idle state while the contents of the stack extension are transferred back to the stack.

8. The method of claim 1, further comprising pushing a new entry onto the stack within the core of the processor after transferring at least a portion of the contents of the stack to the stack extension.

9. The method of claim 8, further comprising:
applying a stack counter to track a number of entries in the stack within the core of the processor; and
determining that the stack contents exceed the threshold size when the stack counter reaches a threshold value.

10. The method of claim 1, further comprising applying a common stack counter to track entries in both the stack within the core and the stack extension.

11. The method of claim 1, further comprising:
determining that the contents fall below a second threshold size; and
transferring at least a portion of the stack extension outside the core of the processor to the stack within the core of the processor when the stack falls below the second threshold size.

12. The method of claim 1, further comprising adjusting a counter to track the portion of the stack contents transferred to the stack extension.

13. The method of claim 1, wherein transferring at least a portion of the contents of the stack comprises transferring the portion of the contents of the stack on a data bus utilized by other resources of the processor.

14. The method of claim 1, wherein the stack extension outside of the core of the processor comprises a stack extension within a common cache of the processor.

15. The method of claim 1, wherein the stack extension outside of the core of the processor comprises a stack extension within a memory outside of the processor.

16. The method of claim 1, wherein transferring at least a portion of the contents of the stack comprises transferring an entire contents of the stack.

17. The method of claim 1, wherein the stack extension comprises a first stack extension, the method further comprising transferring at least a portion of the contents of the first stack extension to a second stack extension when the contents of the first stack extension exceeds a threshold size.

18. The method of claim 1, wherein the core is a first core, the stack is a first stack, and the stack extension is a first stack extension, the method further comprising:
determining whether contents of a second stack within a second core of the processor exceeds a threshold size; and
transferring at least a portion of the contents of the second stack to a second stack extension outside the second core of the processor when the contents of the second stack exceed the threshold size.

19. The method of claim 1, wherein the first and second stack extensions reside within a common cache memory.

20. The method of claim 1, further comprising accessing the stack and the stack extension as a continuous cache.

21. A device comprising:
a processor with a processor core that includes:
a control unit to control operation of the processor, and
a first memory storing a stack within the processor core; and
a second memory storing a stack extension outside the processor core,
wherein the control unit transfers at least a portion of contents of the stack to the stack extension when the contents of the stack exceed the threshold size.

22. The device of claim 21, wherein the stack includes a plurality of stacks within the core of the processor, each of the plurality of stacks corresponding to a different one of a plurality of threads of an application executed by the processor, the stack extension includes a plurality of stack extensions outside the core of the processor, each of the stack extensions corresponding to one of the stacks within the core of the processor, and wherein the control unit transfers at least a portion of contents of one of the stacks within the core of the processor to a corresponding stack extension.

23. The device of claim 22, wherein each of the stacks is equally sized and a number of the stacks corresponds to a number of the threads.

24. The device of claim 22, wherein each of the stacks is sized differently for different applications.

25. The device of claim 22, wherein the control unit transfers at least a portion of the contents of a second one of the stacks within the core of the processor to a corresponding stack extension.

26. The device of claim 21, wherein the stack within the core of the processor is associated with a thread of an application, wherein the control unit places the thread of the application in an idle state while contents of the stack within the core of the processor are transferred to the stack extension.

27. The device of claim 26, wherein the control unit transfers the contents of the stack extension back to the stack, and places the thread of the application in an idle state while the contents of the stack extension are transferred back to the stack.

28. The device of claim 21, wherein the control unit pushes a new entry onto the stack within the core of the processor after transferring at least a portion of the stack contents to the stack extension.

29. The device of claim 28, wherein the control unit increments a stack counter to track a number of entries in the stack within the core of the processor, and determines that the stack contents exceed the threshold size when the stack counter reaches a threshold value.

30. The device of claim 21, wherein the control unit increments a common stack counter to track entries in both the stack within the core and the stack extension.

31. The device of claim 21, wherein the control unit determines that the stack contents falls below a second threshold size, and transfers at least a portion of the stack extension outside the core of the processor to the stack within the core of the processor when the stack falls below the second threshold size.

32. The device of claim 21, further comprising a counter that tracks the portion of the stack contents transferred to the stack extension.

33. The device of claim 21, wherein the control unit transfers the portion of the stack contents on a data bus utilized by other resources of the processor.

34. The device of claim 21, wherein the stack extension outside of the core of the processor comprises a stack extension within a common cache of the processor.

35. The device of claim 21, wherein the stack extension outside of the core of the processor comprises a stack extension within a memory outside of the processor.

36. The device of claim 21, wherein the control unit transfers the entire contents of the stack.

37. The device of claim 21, wherein the stack extension comprises a first stack extension, and the control unit transfers at least a portion of the contents of the first stack extension to a second stack extension when the contents of the first stack extension exceeds a threshold size.

38. The device of 21, wherein the core is a first core, the stack is a first stack, and the stack extension is a first stack extension, and the control unit:
determines whether contents of a second stack within a second core of the processor exceeds a threshold size; and
transfers at least a portion of the contents of the second stack to a second stack extension outside the second core of the processor when the contents of the second stack exceed the threshold size.

39. The device of claim 21, wherein the first and second stack extensions reside within a common cache memory.

40. The device of claim 21, wherein the control unit accesses the stack and the stack extension as a continuous cache.

41. A computer-readable medium comprising instructions to cause a processor to:
determine whether contents of a stack within a core of the processor exceeds a threshold size; and
transfer at least a portion of the contents of the stack to a stack extension outside the core of the processor when the contents of the stack exceed the threshold size.

42. The computer-readable medium of claim 41, wherein the instructions cause the processor to:
maintain a plurality of stacks within the core of the processor, wherein each of the plurality of stacks corresponds to a different one of a plurality of threads of an application executed by the processor; and
maintain a plurality of stack extensions outside the core of the processor, wherein each of the stack extensions corresponds to one of the stacks within the core of the processor,
wherein transferring at least a portion of the contents comprises transferring at least a portion of the contents of one of the stacks within the core of the processor to a corresponding stack extension.

43. The computer-readable medium of claim 41, wherein the stack within the core of the processor is associated with a thread of an application, and the instructions cause the processor to place the thread of the application in an idle state while the contents of the stack within the core of the processor are transferred to the stack extension.

44. The computer-readable medium of claim 41, wherein the instructions cause the processor to transfer the contents of the stack extension back to the stack, place the thread of the application in an idle state while the contents of the stack extension are transferred back to the stack.

45. The computer-readable medium of claim 41, wherein the instructions cause the processor to:
determine that the contents fall below a second threshold size; and
transfer at least a portion of the stack extension outside the core of the processor to the stack within the core of the processor when the stack falls below the second threshold size.
